(19) United States
(12) Patent Application Publication
(10) Pub. No.: US 2026/0006036 A1
(43) Pub. Date: Jan. 1, 2026

(54) DETECTING SECURITY THREATS FROM LOGON DATA

(71) Applicant: Wells Fargo Bank, N.A., San Francisco, CA (US)

(72) Inventors: Saibala Lakkaraju, Mckinney, TX (US); Srinivas Chava, Suwanee, GA (US); Kristine Wetch, Goodyear, AZ (US); Naga lakshmi subha pavan kumar Ghantasala, Addison, TX (US); Moshe Adam Van Berg, Centennial, CO (US); Elvis Dang, Indian Trail, NC (US); Vamsi Kadiyala, Media, PA (US); Satish Raj Katakam, Exton, PA (US)

(21) Appl. No.: 18/756,854

(22) Filed: Jun. 27, 2024

(51) Int. Cl. H04L 9/40; G06N 3/088; G06N 3/09

(52) U.S. Cl. CPC H04L 63/1408; G06N 3/088; G06N 3/09; H04L 63/1441

(57) ABSTRACT

This disclosure describes techniques for analyzing network traffic to generate an actionable insight pertaining to a security threat to a network. In one example, this disclosure describes a method that includes obtaining, by a computing system, historical network activity data that includes information about authentication traffic within a network; determining, by the computing system and based on the historical network activity, a baseline of network activity; collecting, by the computing system, a set of network activity data; applying, by the computing system, an unsupervised algorithm to identify the set of network activity data as anomalous relative to the baseline of network activity; classifying, by the computing system, the network activity data into an identified threat category from among a plurality of threat categories; and taking action, by the computing system and based on the identified threat category, to mitigate a security threat posed by the network activity data.

### TECHNICAL FIELD

This disclosure relates to computer networks, and more specifically, to evaluating network activity in a cloud environment.

### BACKGROUND

Cloud computing is the delivery of computing services over a network, often the internet. Service providers offering services through the cloud are sometimes referred to as software as a service (“SaaS”) providers. Such SaaS providers tend to offer services to its customers (“clients”) in a way that provides convenience, fast innovation, flexible resources, and economies of scale. An organization may manage access to SaaS services to ensure security.

### SUMMARY

This disclosure describes techniques for determining baselines of login activity and detecting anomalous activity in a SaaS system using machine learning (ML) models. A given SaaS system may include a number of services, such as applications and data repositories, accessible to users. An organization, such as an organization that manages the SaaS system, may control access to the various services through user credentials. An analysis system implementing the techniques described herein may determine baselines of network activity and identify anomalous network activity that is inconsistent with baseline activity and/or consistent with malicious activity. The analysis system may use one or more types of models, including an unsupervised machine learning model, to identify suspicious login activity or potentially threating activity.

In some examples, techniques described herein include using an unsupervised ML model to identify anomalous network activity. Feedback from a subject matter expert (SME) may be used to develop tagging rules that enable anomalies identified by the unsupervised ML model to be classified into threat categories. The unsupervised ML model and the tagging rules may be used in tandem. For instance, the unsupervised ML model may identify novel attack patterns and threat categories that the tagging rules are unable to classify.

The techniques described herein may provide certain technical advantages. For instance, an analysis system implementing the techniques described herein may identify attacks that are designed to “fly under the radar” of typical security systems by slowly and precisely attempting to gain access to services within a SaaS system, while remaining below activity levels required to trigger typical security systems. The analysis system may use ML models that learn from login data of the SaaS system while leveraging feedback from subject matter experts to improve the identification of anomalous behavior over time. Further, the analysis system may enable faster and more accurate identification of attack vectors within the SaaS system than traditional techniques that may be unable to identify the range of potential issues due to the complexity of the SaaS system. As a result, the analysis system may more effectively maintain security of a SaaS system than traditional security techniques.

In some examples, this disclosure describes operations performed by a computing system in accordance with one or more aspects of this disclosure. In one specific example, this disclosure describes a method comprising obtaining, by a computing system, historical network activity data that includes information about authentication traffic within a network; determining, by the computing system and based on the historical network activity, a baseline of network activity; collecting, by the computing system, a set of network activity data; applying, by the computing system, an unsupervised algorithm to identify the set of network activity data as anomalous relative to the baseline of network activity; classifying, by the computing system, the network activity data into an identified threat category from among a plurality of threat categories; and taking action, by the computing system and based on the identified threat category, to mitigate a security threat posed by the network activity data.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

### BRIEF DESCRIPTION OF THE DRAWINGS

FIG. 1A is a conceptual diagram illustrating an example system for collecting information about network traffic, in accordance with one or more aspects of the present disclosure.

FIG. 1B is a conceptual diagram illustrating an example system for analyzing network traffic to generate an actionable insight, in accordance with one or more aspects of the present disclosure.

FIG. 2 is a block diagram illustrating an example analysis system that monitors network activity in a distributed network, in accordance with one or more aspects of the present disclosure.

FIG. 3 is a conceptual diagram illustrating a process for identifying anomalous network activity, in accordance with one or more aspects of the present disclosure.

FIG. 4 is a flow diagram illustrating operations for training a supervised model, in accordance with one or more aspects of the present disclosure.

FIG. 5 is a flow diagram illustrating operations performed by an example analysis system, in accordance with one or more aspects of the present disclosure.

### DETAILED DESCRIPTION

As attack surfaces for publicly accessible software as a service applications increase, keeping up with the latest attack vectors using rule-based monitoring is difficult. This disclosure describes a framework that develops a baseline of logon and other activity and uses that baseline to detect anomalous logons from authentication traffic. Specifically, network activities are monitored and compared to the baseline of logon activity to determine whether the network activity is normal or anomalous. Threats to a network and/or potentially malicious behavior can be identified in many cases based on detected anomalous logins.

To develop a baseline of activity, and to determine if new network activity is anomalous, various attributes of network activity are monitored. These attributes may include the IP address of a device that is the source of the authentication activity, the user agent or type of device involved, the location of the device, the status of the login (e.g., login success or failure and/or success rate), and other attributes.

The framework may use unsupervised machine learning algorithms to inspect network traffic and identify anomalies. Those anomalies will tend to identify network activity that may be part of an attack pattern or that could lead to malicious activity. Detecting the anomalies enables the network or network administrators to take action to counter the potential threat or mitigate its effects, even if the precise nature of the threat is unknown.

The output of the unsupervised machine learning model may also be enhanced by creating customized tagging rules to identify known patterns of anomalous activity. For example, a subject matter expert might evaluate the network activity and develop an understanding of the nature of the threat to the network. Based on such an understanding, the subject matter expert may be able to map the anomalous traffic to identifiable threats happening in the network environment and develop tagging rules to identify or label similar anomalous activity when it occurs in the future. Thereafter, anomaly scores generated by an unsupervised machine learning model can be augmented by the tagging rules to enable identification of specific known patterns that correspond to outputs from the unsupervised machine learning model. Alternatively, or in addition, and to the extent that the tagging rules enables labeling of known anomalous behavior patterns, it may be possible to use labeled behavior patterns to train a supervised machine learning model to predict known patterns from network activity. As additional techniques are analyzed and labeled, and models are further trained, the framework becomes more capable of translating various types of anomalous behavior to specific attack techniques with little to no supervision.

Accordingly, the framework can not only identify known threats or known attack patterns, but also continue to detect unknown zero-day attacks targeted at a network by identifying anomalous behavior, even if the framework cannot identify the type of threat represented by the behavior. In other words, the framework also enables network administrators and other stakeholders to at least identify and possibly understand unknown and/or new attack paths which cannot be identified using rule-based monitoring (e.g., ongoing under-the-radar attack patterns which may have evaded other detection efforts). Effectively, the framework enables consistent and/or continuous reconnaissance about activity taking place on the network, enabling quick identification of behaviors that are new or are a departure from normal observed behavior. The framework can therefore also continue to adapt to changing attack vectors, techniques, threats, and access control attacks.

The framework can be extended to learn from the initial model output findings to predict the attack techniques with higher fidelity. In some examples, the framework applies or accounts for an organizational or business context (e.g., contextual information) when observing network activity, so that known activities of the organization or business are less likely to erroneously identified as anomalous network activity. Effectively, organizational or business context is used to filter out noise, so the framework is able to focus less on known network activity, and instead, focus more intensely on unknown activity.

The techniques described herein may be particularly applicable to maintaining security of a network that includes various “Software as a Service” (SaaS) systems, and in particular, such techniques may include identifying anomalous network activity that may be indicative of malicious activity within the SaaS system. A given SaaS system may include a number of services such as applications and data repositories intended to be accessible by users of the SaaS system, such as an organization that operates and/or controls the SaaS system (e.g., a financial institution that operates the SaaS system for use by employees across a number of physical locations). The organization may manage credentials, such as login credentials of users and/or software components, for access to the services provided by the SaaS system. In addition, the organization may monitor login activity throughout the SaaS system in an effort to maintain security of the SaaS system.

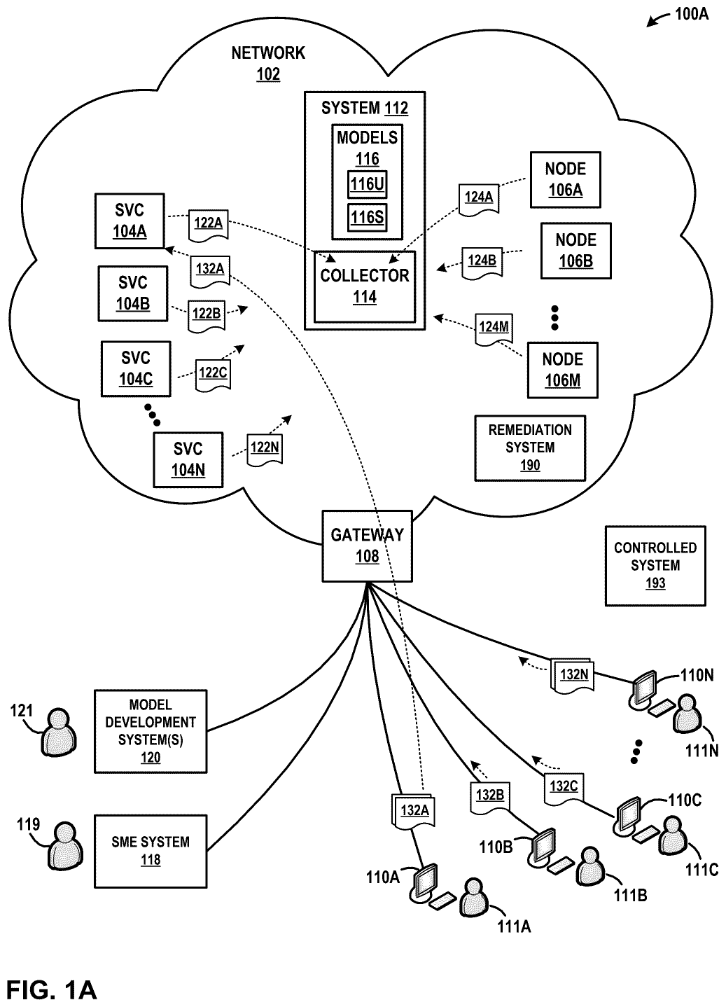

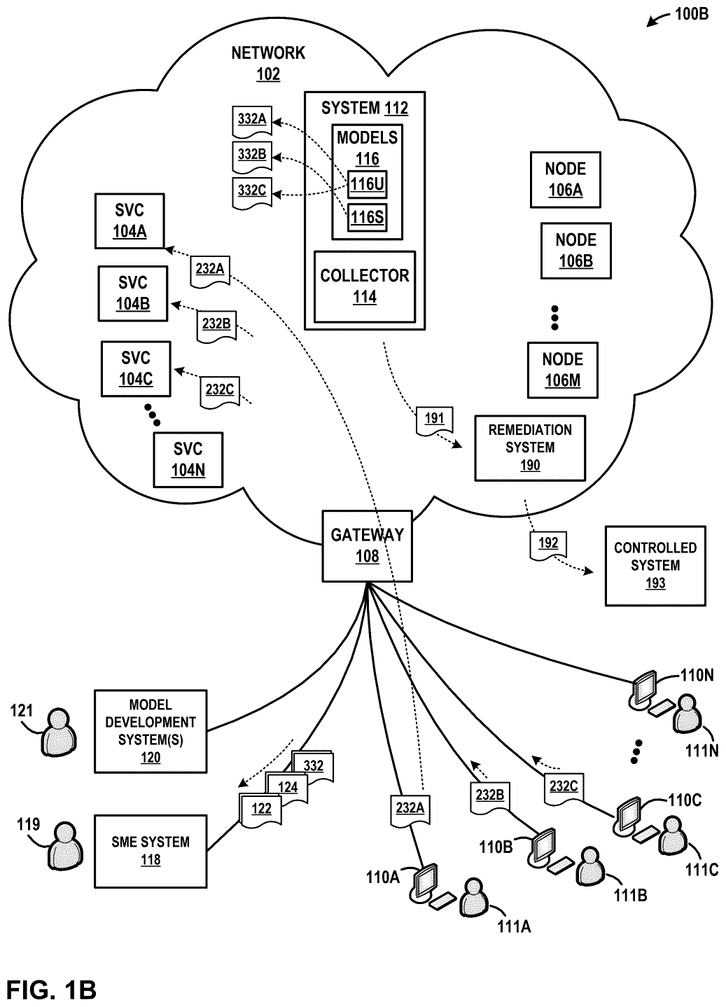

FIG. 1A is a conceptual diagram illustrating an example system 100 for collecting information about network traffic, in accordance with one or more aspects of the present disclosure. In the example of FIG. 1A, system 100 includes network 102, gateway 108, user devices 110A-N (hereinafter “user devices 110”), SME system 118, one or more of model development systems 120, and one or more controlled systems 193.

Network 102 may include one or more networks, such as cloud networks (e.g., public cloud, private cloud), distributed networks, remote networks, on-premises networks, and/or other types of networks. Network 102 may be a network that logically connects one or more services, such as SaaS services, together within a network or collection of networks. For example, network 102 may support a plurality of SaaS services executed by hardware in multi-locations and provide access to the plurality of SaaS services as a single point of contact for the services.

As shown in FIG. 1A, Network 102 includes services 104A-N (hereinafter “services 104”). Services 104 may be one or more types of services such as cloud services that provide functionality for users of network 102. For example, services 104 may include one or more services such as financial services applications, services that provide access to databases, and other types of services.

Network 102 also includes nodes 106A-M (“nodes 106”). Nodes 106 may include one or more types of hardware and software network infrastructure components. Nodes 106 may underlie one or more of services 104. For example, nodes 106 may include network management software that manages the operation of and access to services 104.

Access to network 102 by systems external to network 102 may be through gateway 108. Gateway 108 may include one or more hardware and/or software components such as network routers, network switches, network management software, and other types of components. Gateway 108 may facilitate access to components and services provided by network 102 for devices external to network 102, and providing routing services to external systems that enable access to systems within network 102. For example, gateway 108 may enable user device 110A to access the functionality of any of services 104.

Analysis system 112 (or “system 112”) may perform functions relating to collecting and analyzing information about activity within network 102. Analysis system 112 includes collector module 114 and one or more models 116.

Collector module 114 may perform functions relating to obtaining network activity data from services 104 and/or nodes 106. Collector module 114 may obtain network activity data via one or more techniques such as polling other devices or systems within network 102 (e.g., services 104 and nodes 106), scraping network data from such devices or systems, and other techniques to obtain network activity data. Collector module 114 may obtain network activity data that includes login data 122A-N (collectively “login data 122”) and network data 124A-N (collectively “network data 124”). For example, collector module 114 may cause services 104 to report logins originating from user devices 110 that are processed by services 104. Such login information is illustrated in FIG. 1A as various instances of login data 122. Collector module 114 may also obtain historical network activity data, which may include historical records of network activity and recent network activity data that includes network activity within a predetermined recent period of time (e.g., network within the last day, week, hour, etc., from a present moment in time). In an example, collector module 114 identifies services 104 and nodes 106 as sources from which data may be collected. Collector module 114 outputs a request, to each of services 104 and nodes 106, for network activity data information. In some examples, the request may specify a period of time and the type of data sought. In response, collector module 144 receives, from each of services 104 and nodes 106, the requested network activity data, which may include includes login data 122 from services 104 and network data 124 from nodes 106.

Models 116, illustrated in FIG. 1A as being included within analysis system 112, may include one or more types of machine learning models. For instance, models 116 may include an unsupervised machine learning model (e.g., model 116U) used to identify anomalous activity within network 102. Model 116U may be capable of learning from historical network data without labeled data, and/or without human supervision. In some examples, model 116U is provided unlabeled historical network activity data and allowed to discover patterns and insights without any explicit guidance or instruction. In some examples, model 116U may be implemented by an isolated forest algorithm.

Models 116 of analysis system 112 may also include one or more supervised machine learning algorithms (e.g., model 116S), which may be used to classify, categorize, or identify certain types of known network activity susceptible of being tagged or labeled using rules describing the network activity.

Analysis system 112 may be implemented as any suitable computing system, including one or more server computers, workstations, mainframes, appliances, cloud computing systems, and/or other computing devices that may be capable of performing operations and/or functions described in accordance with one or more aspects of the present disclosure. In other examples, analysis system 112 may represent or be implemented through one or more virtualized compute instances (e.g., virtual machines, containers) of a data center, cloud computing system, server farm, and/or server cluster. In these or examples, analysis system 112 may be accessible over a network as a web service, website, or other service platform. Analysis system 112 is primarily illustrated and described herein as separate and distinct from services 104 and nodes 106. However, in other examples, some or all aspects of analysis system 112 may be incorporated into other systems shown included within network 102, including nodes 106.

Remediation system 190 may provide functions relating to acting on actionable insights generated by analysis system 112. In some examples, remediation system 190 may be a security information and event management (SIEM) system that operates with analysis system 112 for the purpose of helping an organizations operating network 102 to identify and respond to potential security threats and vulnerabilities. In such an example, remediation system 190 may help collect, correlate, and analyze data from various sources to help security analysts spot threats that might otherwise go undetected. Remediation system 190 may also help organizations comply with reporting requirements and mitigate issues that could harm the organization. In some examples, remediation system 190 may integrated into and/or be a part of analysis system 112.

Remediation system 190 may also interact with one or more other downstream systems, including, for example, one or more controlled systems 193. In some examples, analysis system and/or remediation system may send control signals 192 to control aspects of the operation of controlled system 193. Specifically, analysis system 112 (or remediation system 190) may send control signals to controlled system 193, instructing controlled system 193 to perform a specific operation. In one example, controlled system 193 may be instructed to take an action to counter or account for a potential risk to network 102. Accordingly, analysis system 112 and/or remediation system 190 may control the operation of controlled system 193.

Model development systems 120 may perform functions relating to development, training, or calibration of models 116. In some examples, model development systems may be operated by a developer 121 and/or data scientist. Each of model development systems 120 may be implemented by any appropriate computing system, which may include local systems, cloud computing systems, one or more physical or virtualized compute instances (e.g., virtual machines, containers) of a remote data center, cloud computing system, server farm, and/or server cluster. At least some aspects of model development systems 120 may therefore be accessible over a network as a web service, website, or other service platform. Model development systems 120 are primarily illustrated and described herein as separate and distinct from analysis system 112 and implemented outside of network 102. However, in other examples, some or all aspects of model development systems 120 may be incorporated into other systems shown included within network 102, including nodes 106 or analysis 112. In general, model development systems 120 may manage the development of models 116. For example, model development systems 120 may manage and/or administer the creation or application of tagging rules as described herein.

Subject matter expert (“SME”) system 118 may perform functions relating to enabling subject matter experts (e.g., subject matter experts 119) to provide input and/or feedback about the development of tagging rules, supervised machine learning models, and other domain-specific topics. In some examples, SME system 118 may enable an SME to provide feedback and assist in the development of tagging rules used in the development of the supervised ML models. SME system 118 may provide feedback such as modifications of one or more tagging rules. In addition, SME system 118 may provide feedback that includes annotations of network activity data for use in training a supervised ML model. Analysis system 112 may integrate input and/or feedback received from SME system 118 during the development of one or more of models 116. For example, analysis system 112 may train an ML model of models 116 using data annotated by SME system 118.

Like model development systems 120, SME system 118 may be implemented by any appropriate computing system, which may include local systems, cloud computing systems, one or more physical or virtualized compute instances (e.g., virtual machines, containers) of a remote data center, cloud computing system, server farm, and/or server cluster. At least some aspects of SME system 118 may therefore be accessible over a network as a web service, website, or other service platform. SME system 118 is primarily illustrated and described herein as separate and distinct from analysis system 112 and implemented outside of network 102. However, in other examples, some or all aspects of SME system 118 may be incorporated into other systems shown included within network 102, including nodes 106 or analysis 112.

User devices 110 may implemented as any appropriate computing device, which may include devices such as laptops, desktops, smartphones, tablet computers, augmented reality (AR) glasses/goggles, or virtual reality (VR) glasses/goggles. Any of user devices 110 may, in some cases, correspond to other types of computing devices (e.g., servers, mainframes, virtual machines (VMs)). In many cases, user devices 110 are collectively implemented through a geographically distributed set of diverse computing devices across multiple physical offices of an organization. In some examples, some of these user devices 110 may include one or more automated services or devices executing software that autonomously interacts with services 104.

As described herein, each of user devices 110 may engage in authentication activity on network 102. Specifically, each of user devices 110 may log into one or more services 104 of network 102 in order to access functionality provided by services 104. In an example, user device 110B may transmit user credentials (e.g., included within authentication request 132B) to service 104A. Service 104A processes the user credentials and determines whether to allow user device 110B to access the functionality of service 104A.

In FIG. 1A, and in accordance with one or more aspects of the present disclosure, user device 110A may engage in authentication activity with one or more of services 104. For instance, in an example that can be described in the context of FIG. 1A, user device 110A detects input (e.g., from user 111A) that it determines corresponds to a request to authenticate with one of services 104. Based on the input, user device 110A outputs authentication request 132A to network 102. Gateway 108 of network 102 determines that authentication request 132A is destined for one of services 104, such as service 104A. Gateway 108 routes authentication request 132A to service 104A. Service 104A evaluates authentication request 132A and determines whether user device 110A (or user 111A) can be authenticated based on authentication request 132A. If service 104A determines that authentication request 132A can be authenticated, service 104A enables user device 110A to access some or all of the services provided by service 104A. If service 104A does not approve authentication request 132A, service 104A may deny user device 110A access to services provided by service 104A.

Similarly, user device 110A may also detect input that it determines corresponds to additional authentication requests 132, each of which may be an attempt to gain access to other services 104. For example, user device 110A may output other authentication requests 132 to other services 104 (e.g., any of services 104B through 104N). In each case, user device 110A outputs an authentication request 132, and gateway 108 routes each authentication request 132 to the appropriate service 104. Each service 104 makes a determination about whether user device 110A can be authenticated based on the corresponding authentication request 132.

Other user devices 110 may similarly access one or more of services 104. For example, user device 110B may detect input (e.g., from user 111B) that user device 110B determines corresponds to a request to authenticate with one of services 104. Based on the input, user device 110B outputs authentication request 132B to network 102. Gateway 108 of network 102 determines that authentication request 132B is directed to one of services 104, such as service 104B. Gateway 108 routes authentication request 132B to service 104B, and service 104B either authenticates or refuses to authenticate user device 110B based on authentication request 132B. Like user device 110A, user device 110B may seek to authenticate with other services 104. such as by sending to each such service 104 a separate authentication request 132. And in general, user device 110N may detect input that user device 110N determines corresponds to one or more authentication requests 132N, each of which may be routed to one or more of services 104.

Analysis system 112 may observe and store authentication activity taking place on network 102. For instance, continuing with the example being described in the context of FIG. 1A, collector module 114 of analysis system 112 observes activity taking place on network 102. Collector module 114 collects information about authentication requests 132 from user devices 110 and how each of services 104 have responded to such authentication requests 132. In some examples, collector module 114 may observe network traffic occurring on network 102 and collect information or attributes about authentication requests 132 and how each of services 104 have responded to such requests. In some examples, collector module 114 may passively collect information about the network activity, such as by observing traffic. In other examples, one or more of services 104 may actively report information about authentication activity being processed by that service 104. In such an example, and as part of processing authentication requests 132, each of services 104 output login data 122 to collector module 114 of analysis system 112. Specifically, when service 104A processes authentication request 132A, service 104A outputs login data 122A to collector module 114, where such login data 122A may provide information about attributes of authentication request 132A. Similarly, when service 104B processes authentication request 132B, service 104B outputs login data 122B to collector module 114, providing information about attributes of authentication request 132B. And in general, when service 104N processes one or more of authentication requests 132N, service 104N outputs login data 122N to collector module 114, providing information about attributes of such authentication requests 132N.

The attributes of the authentication requests 132 may include information such as the time each authentication request 132 was made, properties of the user device 110 that initiated the request, the application type sought to be authenticated for, the authentication method, the request type, the user agent involved, the authentication status (e.g., whether authentication request 132A was approved or denied), and other attributes. Collector module 114 may store each instance of login data 122 in a data store for analysis.

Analysis system 112 may observe and store information about other activity taking place on network 102. For instance, still continuing with the example being described in the context of FIG. 1A, collector module 114 observes operations performed by one or more of nodes 106. In some examples, services 104 may be supported by various nodes 106, which provide computing infrastructure or networking infrastructure to support various services provided by services 104. Information about operations taking place at nodes 106 may provide additional insights into activity that may pose a threat to network 102. Such information may be relevant to determining whether there is an ongoing or potential threat to aspects of network 102 (e.g., a threat posed by a user device 110 that was able to gain unauthorized access to one or more of services 104). For example, where one of user devices 110 signs into one service 104 or application, but is now attempting to sign into several of services 104 in a way that is outside the norm, that may indicate that the user device 110 (or a user operating the user device 110) is probing potential vulnerabilities of network 102. Alternatively, or in addition, the anomalous activity exhibited by that user device 110 may indicate which of services 104 are of interest to the potentially rogue user device 110 and/or which of services 104 are vulnerable. Some users 111 may have accounts that may have privileges that allow access more sensitive details, and assessing the types of information accessed may provide helpful details or a useful characterization of unusual information or behavior that may shed light on certain types of network activity or sensitive resources that might not have been considered as a target. Also, low and slow attacks are sometimes difficult for conventional processes to identify, but if analysis system 112 evaluates a sufficient number of attributes for a given account, and compares the attributes for that account to prior or baseline behavior for that account, threatening behavior might be apparent where that behavior might otherwise have been missed.

Accordingly, each of nodes 106 may report various information, such as network data 124, to collector module 114. Specifically, node 106A may occasionally, periodically, or continually output network data 124A to collector module 114 of 112, providing information about activities taken by both authenticated and unauthenticated user devices 110. Similarly, node 106B may report network data 124B to collector module 114, and in general, node 106M may report network data 124M to collector module 114. Collector module 114 may store each instance of network data 124 in a data store for analysis. Collector module 114 may also collect similar information by merely observing activity on network 102, without being provided with network data 124 by nodes 106.

Analysis system 112 may determine characteristics of normal or baseline activity on network 102. For instance, again continuing with the example being described in the context of FIG. 1A, analysis system 112 accesses previously stored authentication logs and other information, which may include various historical instances of login data 122 and/or historical network data 124. Analysis system 112 evaluates historical login data 122 and historical network data 124 to determine a baseline of activity for specific users and specific devices, but also for categories or types of users and/or categories or types of devices. For example, analysis system 112 may baseline each user's activity for a timeframe encompassing a recent time period (e.g., the most recent 14-day period), which provides a context or an indication of what is normal for that user based on the behavior of that user in that time frame. That context provides a baseline of activity indicating how that user tends to interact with network 102, and specifically, how that user accesses various services 104 within network 102. The context for a specific user may include information about how many IP addresses are used by the devices associated with each user's devices, information about authentication status success rate, information about which services 104 and/or applications have been accessed, information about what types of user devices 110 have been used, information about operations typically performed after successful authentication, and other information.

Similarity, analysis system 112 may evaluate historical login data 122 and historical network data 124 to determine a baseline of activity for different types or categories of users. For example, users having a particular role in an organization may have different usage patterns as compared to users in a different role in the organization. Accordingly, analysis system 112 may develop a different baseline of activity for marketing personnel within an organization, for finance personnel within the organization, or for research personnel within the organization. Such baseline information may indicate how users having differing roles tend to access services 104 within network 102. Similarly, analysis system 112 may develop a baseline of activity for users of a specific service 104, for users operating a specific user device 110, for users accessing services at a specific time of day, or for other contexts. Analysis system 112 stores information about the developed baseline information for analysis by one or more models 116.

FIG. 1B is a conceptual diagram illustrating an example system for analyzing network traffic to generate an actionable insight relating to security of a network, in accordance with one or more aspects of the present disclosure. System 100B of FIG. 1B is similar to system 100A of FIG. 1A, and includes many of the same elements of system 100A described in connection with FIG. 1A. Elements illustrated in FIG. 1B may correspond to earlier-described elements that are identified by like-numbered reference numerals in FIG. 1A.

In FIG. 1B, and in accordance with one or more aspects of the present disclosure, analysis system 112 may analyze new authentication requests 232 in the context of baseline activity of network 102. For instance, in an example that can be described in the context of FIG. 1B, user device 110A detects input associated with request to authenticate with one of services 104, and user device 110A outputs authentication request 232A to network 102. Gateway 108 of network 102 determines that authentication request 232A is a request to authenticate with service 104A, and routes authentication request 232A to service 104A. Collector module 114 of analysis system 112 observes (or receives information about) authentication request 232A. Collector module 114 outputs information about authentication request 232A to model 116U. Model 116U may be an unsupervised machine learning model capable of determining whether authentication request 232A is anomalous when evaluated in the context of historical login data 122 stored at analysis system 112 (and possibly, historical network data 124 stored at analysis system 112). Model 116U analyzes authentication request 232A (and related network activity) and generates anomaly score 332A based on authentication request 232A and the related network activity.

Anomaly score 332A may represent an assessment by model 116U about whether authentication request 232A is an anomalous request relative to the baseline information developed by analysis system 112 (based on information collected by collector module 114). For example, if anomaly score 332A is below a threshold value, anomaly score 332A might indicate that authentication request 232A is not anomalous, suggesting that authentication request 232A (and related network activity) does not represent a threat to network 102. However, if anomaly score 332A is sufficiently high (e.g., above a threshold value), anomaly score 332A might be interpreted as indicating that authentication request 232A is anomalous, suggesting that authentication request 232A (and related network activity) could be part of a threat to network 102.

In some examples, service 104A may have access to anomaly score 332A when evaluating authentication request 232A, thereby enabling service 104A to consider anomaly score 332A when determining whether to approve authentication request 232A. In such an example, service 104A may determine whether to approve or deny authentication request 232A based, at least in part, on anomaly score 332A. Where anomaly score 332A exceeds a threshold, service 104A may be less likely to authorize authentication request 232A, and where anomaly score 332A is below a threshold, service 104 may be more likely to authorized authentication request 232A.

In other examples, however, service 104A might not have access to or might not consider anomaly score 332A when evaluating authentication request 232A. In such examples, service 104A may approve or deny authentication request 232A without considering anomaly score 332A.

Analysis system 112 may take action if anomaly score 332A suggests that authentication request 232A is anomalous. For instance, again with reference to the example being described in the context of FIG. 1B, analysis system 112 evaluates anomaly score 332A to determine whether it indicates a potential threat to 102, such as if anomaly score 332A exceeds a threshold value. Responsive to anomaly score 332A indicating a potential threat, analysis system 112 outputs control signal 191 to remediation system 190. Remediation system 190 evaluates control signal 191 and takes an action based on control signal 191. In some examples, such an action may be chosen to counter a potential threat or limit potential deleterious effects of an unknown threat. Such actions may involve adjusting configurations associated with network 102, adjusting the availability of resources, nodes 106 and/or service 104 available within network 102, or other actions. Remediation actions taken by remediation system 190 may also involve taking action directed to the source of authentication request 232A (i.e., user device 110A). For example, remediation system 190 may continue to monitor actions taken by user device 110A and/or collect information about actions taken by user device 110A, even if anomaly score 332A indicates a threat, in order to learn more about how user device 110A is operating or motives underlying its operation. Remediation system 190 may also restrict access to various resources by user device 110A (e.g., restricting access to services 104, nodes 106, and/or revoking any authentication previously granted to user device 110A). Analysis system 112 may take such actions automatically or after receiving approval of a human administrator or security analyst (e.g., subject matter expert 119 or other personnel).

In general, when analysis system 112 takes action in response to identifying a specific threat, analysis system 112 may send control signals to control one or more other systems. For instance, analysis system 112 may send control signals to remediation system 190, instructing the remediation system 190 to perform a specific operation to mitigate a threat posed by identified network activity. In one example, analysis system 112 takes action in response to a threat by outputting a series of signals to a downstream system, such as remediation system 190, controlled system 193, or both. Remediation system 190 and/or controlled system 193 receives the signals and determines that the signals include instructions for mitigating or otherwise addressing a threat posed by network activity identified by one or more of models 116. Accordingly, analysis system 112 controls the operation of other systems (e.g., remediation system 190 and/or controlled system 193) to cause such other systems to perform an action.

Over time, analysis system 112 may identify patterns in anomalies identified by model 116U. For instance, again continuing with the example being described in connection with FIG. 1B, SME system 118 detects input that it determines corresponds to a request for information about network 102. SME system 118 outputs an information request to network 102, which gateway 108 routes to analysis system 112. Analysis system 112 responds to the request with responsive information. SME system 118 receives, from analysis system 112, the responsive information, which may include historical login data 122, historical network data 124, and information about anomaly scores 332 associated with the instances of historical login data 122 and network data 124. SME system 118 evaluates the information responsive to the request and determines tagging rules that help identify what type of attack is associated with at least some of the instances of the login data 122, network data 124, and corresponding anomaly scores 332. SME system 118 generates labeling data for various attack types and/or rules for how the data can be labeled. In some examples, SME system 118 generates such labeling data and/or rules based in part on input from one or more subject matter experts 119, which may provide input at SME system 118. SME system 118 outputs information about the labeling data, tags, and/or tagging rules to analysis system 112. Analysis system 112 uses the information to augment model 116U, enabling model 116U to use the tagging rules to associate anomaly scores 332 with known patterns of network activity.

Alternatively, or in addition, analysis system 112 may train model 116S to identify a specific threat patterns based on network activity. Analysis system 112 (or another system) may train supervised model 116S using training data that includes labeled attack patterns associated with instances of network activity data (e.g., authentication requests 232, login data 122, and/or network data 124). Once trained, supervised model 116S might not replace unsupervised model 116U, but model 116S may operate in conjunction with and supplement predictions made by unsupervised model 116U.

After training model 116S, analysis system 112 may analyze authentication requests 232 in the context of not just the baseline of activity of networks 102, but also in the context of known threats, as identified by the tagging rules. For instance, still with reference to the example being described in the context of FIG. 1B, user device 110B detects input associated with request to authenticate with one of services 104, and user device 110B outputs authentication request 232B to network 102. Gateway 108 of network 102 determines that authentication request 232B is a request to authenticate with service 104B, and routes authentication request 232B to service 104B. Collector module 114 of analysis system 112 observes (or receives information about) authentication request 232B, and outputs information to both unsupervised model 116U and supervised model 116S. Unsupervised model 116U determines whether authentication request 232B is anomalous. Supervised learning model 116S determines whether authentication request 232B matches any known threats or attack patterns. If model 116S determines that authentication request 232B matches a known pattern of threating network activity, model 116S outputs classification 332B, identifying the known pattern of network activity. Analysis system 212 takes action based on classification 332B by outputting control signal 191 to remediation system 190, enabling remediation system 190 to remediate any such threat associated with the known pattern. In this context, model 116U may also determine that authentication request 232B is anomalous, which may also cause analysis system 112 to take action. However, in at least some examples, any remediation action taken in response to model 116U determining that authentication request 232B is anomalous may be subsumed by actions taken by analysis system 112 in response to model 116S determining that authentication request 232B matches a known pattern of threating activity.

Model 116U may continue to identify anomalous behavior even where model 116S cannot identify a known threat. For instance, once again with reference to the example being described in the context of FIG. 1B, user device 110C detects input associated with request to authenticate with one of services 104, and user device 110B outputs authentication request 232C to network 102. Gateway 108 of network 102 determines that authentication request 232C is a request to authenticate with service 104C, and routes authentication request 232C to service 104C. Collector module 114 of analysis system 112 observes authentication request 232C. In the example being described, authentication request 232C is a threat to network 102, but does not match any known patterns identified by SME system 118. Analysis system 112 outputs information about authentication request 232C to both model 116S and model 116U. Since authentication request 232C does not match any known patterns, tagging rules associated with model 116U and/or reflected within trained supervised model 116S may be unable to determine that authentication request 232C is a known threat to network 102. However, model 116U generates anomaly score 332C which may nevertheless indicate that authentication request 232C is anomalous in some way. Accordingly, anomaly score 332C represents an indication that the authentication request 232C (and/or network activity associated with authentication request 232C) represents a potential threat to network 102. Responsive to model 116U determining that authentication request 232C is anomalous, analysis system 212 takes action by outputting control signals 191 to remediation system 190, which may act to remediate any such threat. Accordingly, by employing both unsupervised model 116U and supervised model 116S (or using tagging rules in conjunction with unsupervised model 116U), analysis system 112 can identify both known patterns of threatening network activity and known attack patterns, but analysis system 112 can also detect unknown zero-day attacks targeted at a network (e.g., using unsupervised model 116U).

In general, analysis system 112 may apply unsupervised model 116U to historical network activity, such as to identify some instances of the historical network activity as anomalous network activity. For example, analysis system 112 may apply an unsupervised ML model to historical network activity to identify instances of anomalous network activity within the historical network activity. Analysis system 112 may identify instances of anomalous network activity, such as misconfigurations within the network, activity consistent with known attack patterns or other malicious activity, activity that is anomalous and potentially consistent with malicious activity, and other instances of anomalous network activity, using the unsupervised ML model.

As described herein, analysis system 112 may classify instances of anomalous network activity into threat categories, which may include categories of potential threats and/or attacks. Analysis system 112 may use threat categories that are predetermined (e.g., based on known types of malicious activity, public databases of attack vectors and techniques, etc.) and threat categories that are identified and/or generated by models 116. For example, analysis system 112 may determine new threat categories based on the identification of novel attack vectors by an unsupervised ML model of models 116. Analysis system 112 may use one or more of models 116 to classify new or recent network activity data into one or more threat categories. In an example, analysis system 112 obtains network activity data using collector module 114 and provides the network activity data to a supervised ML model (e.g., model 116S). The supervised ML model processes the network activity data and identifies anomalous network activity and a corresponding classification of the anomalous activity as one of a plurality of threat categories.

Analysis system 112 may take one or more actions, which may include actions such as activating one or more security components of network 102, modifying or remediating the configuration of one or more of services 104 and/or nodes 124, and/or providing an indication or alert of anomalous network activity categorized into threat categories. For example, analysis system 112 may provide an indication of anomalous network activity within a particular threat category to a network security system, such as remediation system 190. Analysis system 112 may determine what action to take based on the threat category identified one of models 116. In an example, models 116 process network activity data and generate an output that includes an identification of an anomalous network event and a classification of the event that corresponds to a relatively serious security deficiency. Analysis system 112, based on the classification, generates an alert and outputs the alert to multiple devices operated by cybersecurity administrators of network 102.

As described herein, analysis system 112 may generate tagging rules and annotations based on anomaly scores generated by an unsupervised ML model. Analysis system 112 may generate tagging rules, such as rules for annotating for historical network activity data and/or recent network activity, and annotations, such as annotations of the data historical network activity data, for use in training a supervised ML model. For example, analysis system 112 may generate tagging rules that are based on outliers of the output of the unsupervised ML model (e.g., outliers that are consistent with anomalous network activity). Analysis system 112 may generate the tagging rules and annotations using feedback from one or more sources such as subject matter experts (SMEs).

Analysis system 112 may facilitate the development of supervised ML models using the tagging rules and/or data annotations. Analysis system may facilitate the training of a supervised ML model to identify anomalous network activity within network 102. In an example, analysis system 112 applies tagging rules to a set of historical network activity data. Analysis system 112 trains a supervised ML model (e.g., model 116S) based on the tagging rules, thereby enabling the supervised ML model to identify and classify anomalous network activity into a threat category.

The techniques of this disclosure provide one or more practical advantages. The training of an unsupervised ML model which can then be used to develop tagging rules may enable an organization to develop a model capable of classifying network activity for complex systems such as a SaaS platform, without requiring error-prone, difficult to maintain, and complicated ground-up development of a rules-based model. In addition, the use of the unsupervised ML model and tagging rules in tandem to analyze network activity data may enable an organization to combine the consistency of a rules-based model with the ability of the unsupervised to identify novel attack vectors.

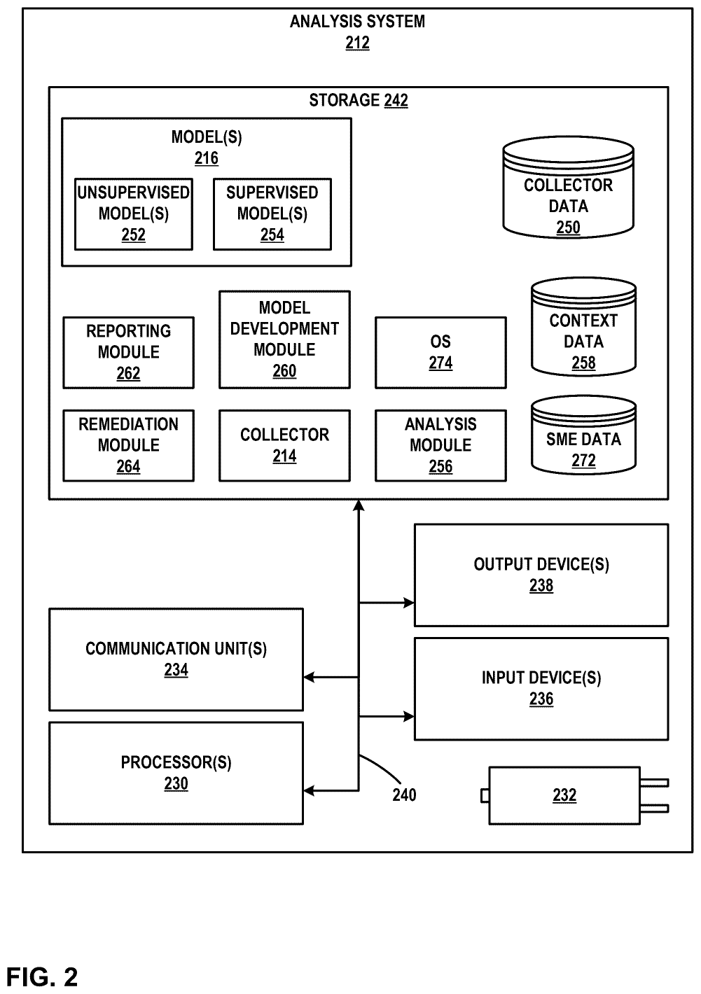

FIG. 2 is a block diagram illustrating an example analysis system 212 that monitors network activity in a network, in accordance with one or more aspects of the present disclosure. Analysis system 212 of FIG. 2 may be considered an example of analysis system 112 of FIG. 1A and FIG. 1B, may operate in a manner similar to analysis system 112 as illustrated in FIG. 1A and FIG. 1B. For example, analysis system 212 may monitor network activity in network 102 and identify anomalies as described in connection with FIG. 1A and FIG. 1B. Analysis system 212 is illustrated in FIG. 2 to facilitate a description of certain components, modules, and other aspects of a computing system that may implement an analysis system, such as analysis system 112 of FIGS. 1A and 1B. Analysis system 212 is also illustrated in FIG. 2 to facilitate a description of how such a computing system may operate in accordance with techniques described herein.

In FIG. 2, analysis system 212 includes one or more processors 230, which mobile processors, desktop processors, server processors, compute nodes, virtualized processors, processing circuitry, and/or other types of processors. Processors 230 may execute the instructions of one or more processes of analysis system 212 and implement functionality of the one or more processes.

Analysis system 212 includes one or more of communication units 234, which may include one or more components such as network interface cards (NICs), wireless radios such as cellular modems and WIFI radios, transceivers, and other components. Communication units 234 may enable analysis system 212 to communicate with other computing devices and systems using any appropriate communication protocol (e.g., TCP/IP). Communication units 234 may enable analysis system 212 to communicate with any other device illustrated in FIGS. 1A and 1B, such as services 104 of network 102.

Analysis system 212 includes power source 232, which may include one or more sources of power such a connection to an electrical grid, a connection to local power sources (e.g., solar, battery, power generation system, or various backup systems), and/or other sources of power. Power source 232 may provide the power that enables analysis system 212 to operate.

Analysis system 212 includes input devices 236 and output devices 238. Analysis system 212 may include one or more devices capable of providing input to analysis system 238 such as keyboards, mice, touchscreens, touchpads, microphones, video cameras, and other types of input devices. Analysis system 212 may include one or more devices capable of generating output such as displays, speakers, haptic engines, light indicators, and other devices capable of generating output.

Analysis system 212 includes communication channels 240, which may include one or more components such as hardware connections, software connections, hardware interconnects, and other components. Communication channels 240 may interconnect one or more components of analysis system 212 and enable communication between the components of analysis system 212. For example, communication channels 240 interconnect processors 230 and storage 242.

Analysis system 212 includes storage 242, which may include one or more storage components such as hard disk drives, solid state drives, magnetic tape drives, disk drives, virtualized storage, and other components. Storage 242 may store instructions and data for one or more software components of analysis system 212. For example, storage 242 may store instructions of an operating system (OS) for execution by processors 230.

Storage 242 includes operating system 274 (illustrated as “OS 274”, hereinafter referred to as the same), which may provide a software platform on which various processes executing on analysis system 212 may operate. In general, OS 274 may provide an execution environment for one or more software components of analysis system 212 such as collector module 214, models 116, analysis module 256, model development module 260, reporting module 262, and/or remediation module 264.

Storage 242 includes collector module 214. Collector module 214 may be similar to collector module 114 as illustrated in FIG. 1A and provide similar functionality. For example, collector module 214 may obtain network activity data that includes login data and/or network data from one or more sources within network 102. Collector module 214 may use one or more components of analysis system 212 to obtain the network activity data. In an example, collector module 214 causes communication units 234 to transmit a request for information to services of network 102. Communication units 234 receive network activity data from the services and provide the data to collector module 214. Collector module 214 may obtain both historical network activity data (e.g., data regarding network activity prior to a particular point in time) and recent network activity data (e.g., data regarding network activity within a range of time relative to a current point in time).

Storage 242 includes collector data store 250, which may be implemented through one or more types of data structures such a database, data lake, or other type of data repository. Collector module 214 may store network activity data in collector data store 250. For example, collector module 214 may maintain a record of network activity in collector data store 250 as a record of historical network activity and recent network activity.

Storage 242 includes analysis module 256. Analysis module 256 may orchestrate the analysis and processing of network activity data (e.g., data maintained in collector data store 250) by one or more components of analysis system 212. In an example, analysis module 256 causes collector module 214 to obtain a more recent set of network activity data than the network activity data currently maintained in collector data store 250. Analysis module 256, based on collector module 214 obtaining the network activity data, causes models 216 to process the network activity data to identify anomalous network activity and classify the anomalous network activity. Based on an identification of anomalous network activity and the classification of anomalous network activity, analysis module 256 causes analysis system 212 to engage mediation module 264 to take remedial action to address the anomalous network activity.

Storage 242 includes models 216, which may be similar to analysis models 116 as illustrated in FIG. 1A and FIG. 1B and provide similar functionality. For example, models 116 may analyze network activity data and identify anomalous network activity within network 102. Models 216 may include one or more ML models such as unsupervised models 252 and supervised models 254. Model 116U of FIGS. 1A and 1B may be an example of unsupervised models 252. Similarly, model 116S of FIGS. 1A and 1B may be an example of supervised models 254.

Unsupervised models 252 may include models such as clustering, associating rules, and/or dimensionality reduction-based ML models. Unsupervised models 252 may include an unsupervised clustering model prepared with pre-training and used to identify anomalous network activity. Unsupervised models 252 may classify network activity into a plurality of categories of network activity with outliers in the classifications representative of anomalous network activity.

Supervised models 254 may be trained and developed using labeled data, and may, as described herein, use data generated by one or more unsupervised models 252 and labeled using domain-specific knowledge and/or subject matter experts.

Analysis module 256 may use unsupervised models 252 to perform initial identifications of anomalous network activity within network 102. Analysis module 256 may provide data from collector data store 250 to one or more of unsupervised models 252 for processing by unsupervised models 252. In an example, analysis module 256 provides network activity data that includes new or recent network activity data from collector data store 250 to unsupervised models 252. Unsupervised models 252 process the network activity data and output an anomaly score, which can be used to characterize the network activity as anomalous or normal. Unsupervised models 252 may identify outliers that correspond to anomalous network activity.

Storage 242 includes model development module 260, which may perform functions relating to facilitating development of unsupervised or supervised ML models. In an example, model development module 260 captures anomaly scores generated by one or more unsupervised models 252, and processes the scores to generate rules, labels, and/or annotations. Model development module 260 may use information obtained from SMEs and stored in SME data store 272 in generating the rules, labels, and annotations. In some examples, models development module may facilitate the development of one or more supervised models 254 using the labeled data. In some cases, such development may be performed by computing systems and devices external to analysis system 212 (e.g., model development systems 120 as illustrated in FIG. 1A).

Storage 242 includes SME data store 272, which may be a data structure such as a database, data lake, and/or other type of data repository. Analysis system 212 may store information from SME system 118 (operated by a subject matter expert 119) in SME data store 272. See FIG. 1A. Analysis system 212 may store information such as feedback from SMEs about anomaly scores and/or classifications determined by unsupervised models 252 and/or supervised models 254. In addition, analysis system 212 may store information regarding feedback from SMEs corresponding to rules and annotations generated based on anomaly scores output by one or more unsupervised models 252. In an example, model development module 260 generates a plurality of rules and annotations based on classifications performed by an unsupervised model 252. Model development module 260 causes communication units 234 to output data about the rules and annotations to recipient devices operated by SMEs (e.g., SME systems 118). Model development module 260 receives feedback from the SMEs regarding modifications to the rules and annotations to be made before developing a supervised model using those rules and annotations.

Model development module 260 may develop supervised models 254 using the rules and annotations based on classifications by unsupervised models 252 and SME data store 272. For example, model development module 260 may use data annotated using the generated annotations to train supervised models 254. Model development module 260 may input the annotated data to a supervised model of supervised models 254 and train the supervised model using the annotated data. In addition, model development module 260 may use the rules to train supervised models 254. In some examples, model development module 260 may use organization information and contexts to train supervised models 254.

Storage 242 includes context data store 258, which may be implemented through one or more types of data structures such a database, data lake, or other type of data repository. Analysis system 212 may store, within context data store 258, information about an organization that manages a network, information about usage characteristics of a network, and/or information about the organizational context of the organization (e.g., business practices, employee types, normal usage patterns).

Model development module 260 may use unsupervised ML models 254 to identify threat categories. Model development module 260 may use classifications by unsupervised ML models 254 as a basis for threat categories that are representative of activity within a distributed network such as attack vectors, malicious activity, misconfiguration of network resources, and other undesirable activity within a distributed network. In an example, model development module 260 processes classifications performed by unsupervised models 252 and correlates the classifications with rationales for the anomalous network activity (e.g., an attack, misconfigured network resources, etc.). Model development module 260 uses feedback obtained from SMEs and stored in SME data store 272 in identifying the threat categories.

Analysis module 256 may use supervised models 254 to classify new, current, or recent network activity data into the threat categories. Analysis module 256 may provide the new network activity to supervised models 254 and receive classifications of anomalous activity as threat categories. Analysis module 256 may classify such network activity data using both unsupervised models 252 and supervised models 254, where unsupervised models 252 identify instances of anomalous activity that supervised models 254 are unable to classify (e.g., a novel attack vector that has not yet been identified as a threat category). In an example, collector module 214 collects a second set of network activity and applies an unsupervised model to the second set of network activity to determine that the network activity is anomalous. Model development module 260 determines that the second set of network activity data is not classifiable into any of the plurality of threat categories. Remediation module 264 takes one or more actions based on the identification of the second set of network activity.

Storage 242 includes remediation module 264 the performs function relating to mitigating or addressing potential negative effects of anomalous or known problematic network activity. Remediation module 264 may take one or more actions to remediate network activity, such as network activity classified into a threat category. In an example, remediation module 264 receives information about network activity that has been classified into a particular threat category and consistent with a number of attackers targeting a particular service. Remediation module 264 may, for example, take action to apply an updated security patch to the particular service to harden the particular service against the threat.

Storage 242 includes reporting module 262, which may perform functions relating to generating and providing reports about classifications of network activity. Analysis system 212 may use reporting module 262 to generate reports/alerts that include information regarding the identification of one or more threats within network 102. Reporting module 262 may generate the reports and/or alerts on a periodic schedule and/or in response to the classification of network activity into particular alert categories. In an example, analysis module 256 classifies, using models 216, that recent network activity within network 102 into a threat category representative of a distributed denial of service (DDOS) attack against a service. Reporting module 262 generates a report that includes information regarding the DDOS attack and causes communication units 234 to transmit the report to recipient devices. Reporting module 262 may generate alerts that indicate the classification of network activity into one or more threat categories and provide the alerts to one or more recipient devices. In some examples, reporting module 262 may generate and transmit, based on the severity of a threat category, an immediate alert instead of merely generating a period report on the network activity of network 102.

Modules illustrated in FIG. 2 (e.g., collector module 214, models 116, analysis module 256, model development module 260, reporting module 262, and/or remediation module 264) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

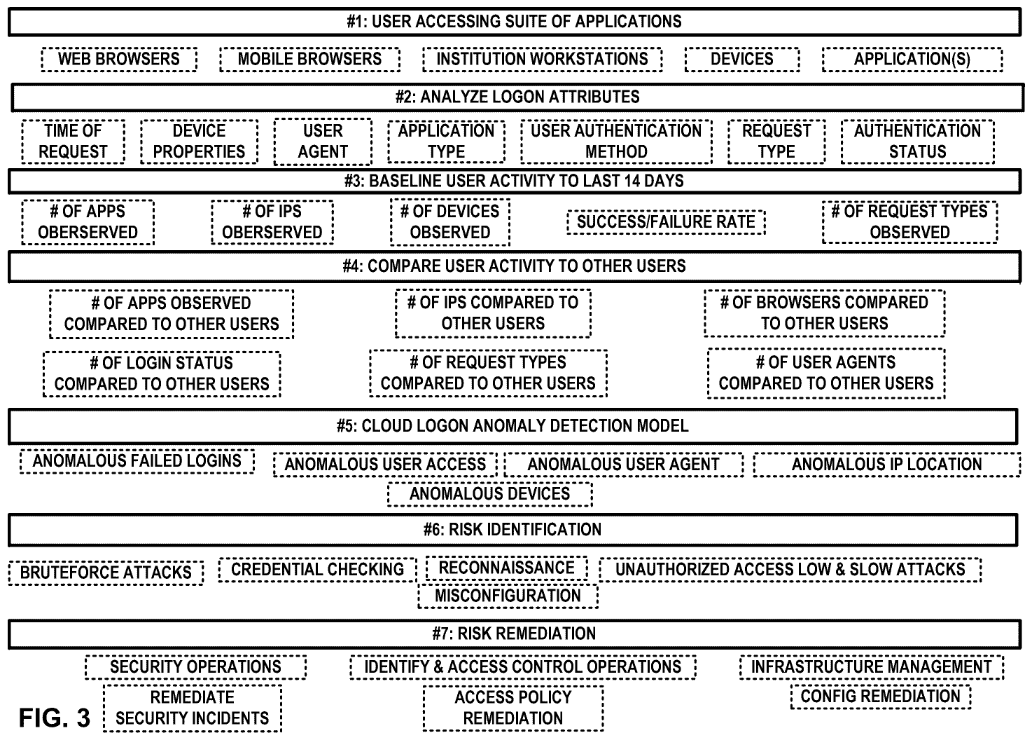

FIG. 3 is a conceptual diagram illustrating a process for identifying anomalous network activity, in accordance with one or more aspects of the present disclosure. For the purposes of clarity, FIG. 3 is discussed in the context of FIG. 1A and FIG. 1B.

Analysis system 112 may cause collector module 114 to obtain one or more types of information from services 104 and/or nodes 106 (e.g., “#1: USER ACCESSING SUITE OF APPLICATIONS” as illustrated in FIG. 3). Collector module 114 may obtain information regarding browsers used by user devices 110 such as information regarding desktop browsers (e.g., “WEB BROWSERS”) and/or regarding browsers of mobile devices (e.g., “MOBILE BROWSERS”) such as tablet computers and smartphones. Collector module 114 may obtain information regarding the type of browser, version number of the browser, plugins used with the browser, and other information.

Collector module 114 may collect information regarding user devices 110 themselves. Collector module 114 may collect information regarding workstations of the organization associated with network 102 (e.g., “INSTITUTION WORKSTATIONS”) and other devices connected to network 102 via gateway 108 (e.g., “DEVICES”). Collector module 114 may collect information such as MAC addresses, IP addresses, operating system type and revision, hardware configuration, associated users, and other information. In an example, collector module 114 polls nodes 106 for information about devices that are connected to nodes 106.

Analysis system 112 may analyze attributes of logins to services 104 (e.g., “#2: ANALYZE LOGON ATTRIBUTES” as illustrated in FIG. 3). Analysis system 112 may use one or more of models 116 to analyze the login attributes. In an example, analysis system 112 uses collector module 114 to collect information regarding user logins. Analysis system 112 uses an unsupervised model of models 116 to analyze the login information. Analysis system 112 may analyze one or more attributes of user logins to services 104, such as time of day of login requests (“TIME OF REQUEST”), properties of the device that made the login request (“DEVICE PROPERTIES”), the user agent that made the login request (“USER AGENT”), the types of applications (e.g., services 104) that the user has attempted to login to (“APPLICATION TYPE”), the type of authentication that the user used to attempt to login to services 104 (“USER AUTHENTICATION METHOD”, e.g., MFA, password, keycode, physical authentication, etc.), the type of request to login (“REQUEST TYPE”), and the status of the authentication (“AUTHENTICATION STATUS”, e.g., pass/fail).

Analysis system 112 may determine a baselines of user activity, such as login activity, for each user of network 102 (e.g., “#3: BASELINE USER ACTIVITY TO LAST 14 DAYS”). Analysis system 112 may determine the baseline by monitoring the login activity of a given user over a predetermined period of time, such as a week, 14 days, a month, or another timeframe. Analysis system 112 may use one or more metrics extracted from login data 122 and/or network data 124 that include a number of applications or services that the user has logged into (“#OF APPS OBSERVED”), the number of IP addresses associated with login attempts from the user (“#OF IPS OBSERVED”), the number of devices observed using login credentials of the user (“#OF DEVICES OBSERVED”), the percentage of attempted logins that were successful (“SUCCESS/FAILURE RATE”), and/or the number of different types of logins observed by analysis system 112 (“#OF REQUEST TYPES OBSERVED”).

Analysis system 112 may compare the baseline of user activity to activity of other users (e.g., “#4: COMPARE USER ACTIVITY TO OTHER USERS”). For example, analysis system 112 may determine the baseline of user activity and compare that baseline to network activity of other users. Analysis system 112 may use one or more metrics to compare the baseline, such as (“#OF APPS OBSERVED COMPARED TO OTHER USERS”), the number of attempted logins and login status (“#OF LOGIN STATUS COMPARED TO OTHER USERS”), the number of IP addresses used to attempt logins compared to other users (“#OF IPS COMPARED TO OTHER USERS”), the number of types of login attempts compared to other users (“#OF REQUEST TYPES COMPARED TO OTHER USERS”), the number of types of browsers used to attempt logins compared to other users (“#OF BROWSERS COMPARED TO OTHER USERS”), and the number of user agents types that attempted logins compared to other users (“#OF USER AGENTS COMPARED TO OTHER USERS”).

Analysis system 112 may apply one or more login anomaly detection models, such as one or more of models 116, to the data collected by collector module 114 (e.g., “#5: CLOUD LOGON ANOMALY DETECTION MODEL”). Analysis system 112 may apply the one or more models to identify anomalous network activity based on anomalous login activity by a user. In an example, analysis system 112 applies models 116 to network activity data to determine whether login activity of a given user has deviated from a baseline of that user or from a baseline compared to other users. Analysis system 112 may identify one or more types of anomalous network behavior such as anomalous failed login attempts (“ANOMALOUS FAILED LOGINS”), anomalous user access to one or more of services 104 (“ANOMALOUS USER ACCESS”), anomalous actions by a user agent (“ANOMALOUS USER AGENT”), IP addresses that correspond to anomalous IP locations (“ANOMALOUS IP LOCATION”), and/or anomalous devices that use the user login credentials (“ANOMALOUS DEVICES”).

Analysis system 112 may identify one or more risks, anomalous activity, and/or malicious activity within network 102 (e.g., “#6: RISK IDENTIFICATION”), such as brute force attacks on one or more of services 104 and/or nodes 106 (e.g., “BRUTEFORCE ATTACKS”), scanning for compromised credentials and/or attempting to use credentials (“CREDENTIAL CHECKING”), reconnaissance of one or more of services 104 and/or nodes 106 (“RECONNAISSANCE”), one or more attacks configured to avoid attack detection systems (“UNAUTHORIZED ACCESS LOW & SLOW ATTACKS”), and/or misconfigurations in network 102 (“MISCONFIGURATION”).

Analysis system 112 may take one or more actions to remediate network 102 (e.g., “#7: RISK REMEDIATION”), such as in response to the identification of one or more instances of anomalous activity. Analysis system 112 may take one or more actions, such as executing security operations (“SECURITY OPERATIONS”), remediation of one or more security incidents using one or more techniques (“REMEDIATE SECURITY INCIDENTS”), identification and accessing of control operations of one or more components of network 102 (“IDENTIFY & ACCESS CONTROL OPERATIONS”), remediation of access policies for one or more of services 104 and/or nodes 106 (“ACCESS POLICY REMEDIATION”), executing one or more management actions to manage infrastructure of network 102 (“INFRASTRUCTURE MANAGEMENT”), and/or modifying configurations of one or more components of network 102 (“CONFIG REMEDIATION”).

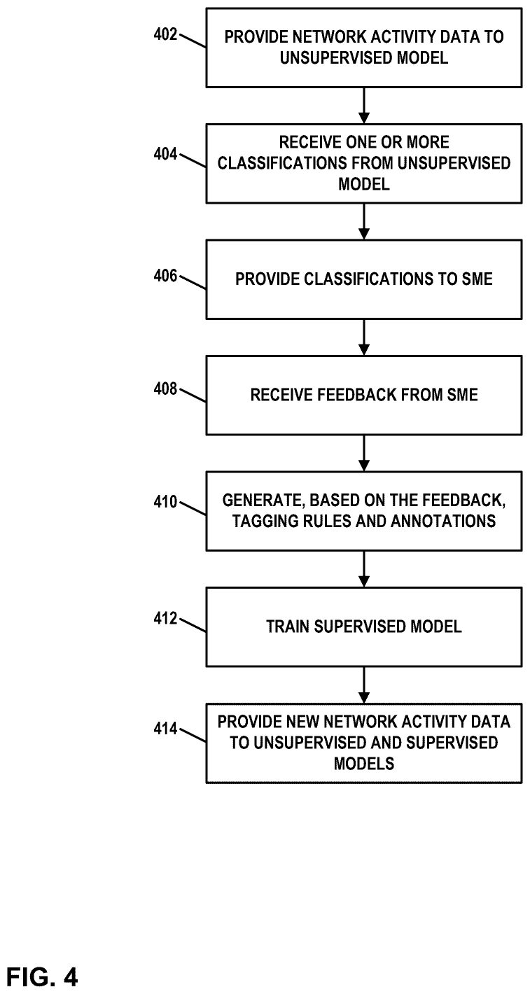

FIG. 4 is a flow diagram illustrating operations for using tagging rules to categorize known network activity, in accordance with one or more aspects of the present disclosure. One or more aspects of FIG. 4 are described in the context of FIG. 2. For example, one or more components of analysis system 212, such as model development module 260, may facilitate or perform the operations of FIG. 4.

Analysis system 212 provides network activity data to one of unsupervised models 252 (402). Analysis system 212 may retrieve network activity data stored in collector data store 250. Analysis system 212 outputs the network activity data to the unsupervised model for processing. In some examples, analysis system 212 may provide to the model, in addition to the network activity data, historical network activity data collected for a prior time period (e.g., the prior 14 days).

Analysis system 212 receives an anomaly score or information indicating an outlier classification from the unsupervised model (404). Analysis system 212 may receive classifications that include identifications of anomalous network activity. For example, analysis system 212 may receive an indication of several instances of anomalous network activity identified by the unsupervised model. Analysis system 212 may receive the classifications as outliers in the output of the unsupervised model (e.g., outliers to classifications of normal network activity). In some examples, analysis system 212, as part of classifying the instances of anomalous network activity, analysis system 212 may enable an SME to create rules for each of the plurality of threat categories and cause one or more components to apply the rules to classify the instances of the anomalous network activity into the plurality of threat categories.

Analysis system 212 provides the classifications by the unsupervised model to one or more SMEs 119 (406) in order to elicit feedback about the classifications and to facilitate the development of rules for a supervised model. Analysis system 212 receives feedback from the one or more SMEs (408), which may include information regarding one or more changes to the classifications. In some examples, analysis system 212 may receive information about one or more threat categories from the one or more SMEs that are is derived from the classifications by the unsupervised model.

Analysis system 212 generates, based on the feedback, tagging rules and annotations (410). For example, analysis system 212 may apply annotations to a set of network activity data for use in training a supervised ML model. Analysis system 212 may use additional information such as organizational context information stored in context data store 258 in generating the tagging rules and annotations.

Analysis system 212 trains a supervised model 254 (412). Analysis system 212 may train the supervised model using information such as the tagging rules and annotated data. For example, analysis system 212 may train the supervised model to identify and classify anomalous network activity within network 102.

Analysis system 212 provides new network activity data to the unsupervised and supervised models (414). For example, analysis system 212 may provide new network activity data collected during a period of time leading up to the current point in time. Analysis system 212 may provide the new network activity data to both unsupervised and supervised models. The unsupervised model determines whether the new network data is anomalous. The supervised model attempts to identify and classify the new network activity.

By employing both a supervised model and an unsupervised model, analysis system 212 can identify both known threats and attack patterns (e.g., using the supervised model), but can also detect unknown zero-day attacks targeted at a network (e.g., using unsupervised model).

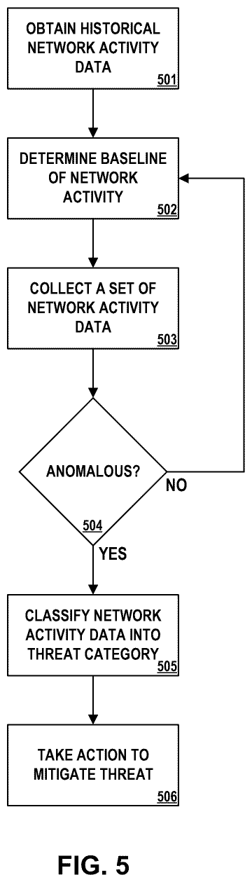

FIG. 5 is a flow diagram illustrating operations performed by an example analysis system in accordance with one or more aspects of the present disclosure. FIG. 5 is described below within the context of analysis system 122 of FIGS. 1A and 1B. In other examples, operations described in FIG. 5 may be performed by one or more other components, modules, systems, or devices. Further, in other examples, operations described in connection with FIG. 5 may be merged, performed in a difference sequence, omitted, or may encompass additional operations not specifically illustrated or described.

FIG. 5 is a flow diagram illustrating operations performed by an example analysis system, in accordance with one or more aspects of the present disclosure. FIG. 5 is described below within the context of analysis system 112 operating within system 100A of FIG. 1A and system 100B of FIG. 1B. In other examples, operations described in FIG. 5 may be performed by one or more other components, modules, systems, or devices. Further, in other examples, operations described in connection with FIG. 5 may be merged, performed in a difference sequence, omitted, or may encompass additional operations not specifically illustrated or described.

In the example of FIG. 5, and in accordance with one or more aspects of the present disclosure, analysis system 112 may obtain historical network activity data (501). For example, in FIG. 1A, service 104A receives authentication request 132A from user device 110A. Service 104A outputs information about authentication request 132A to analysis system 112. Collector module 114 of analysis system 112 detects input that it determines corresponds to login data 122A. Similarly, service 104B receives authentication request 132B from user device 110B, and outputs login data 122B to collector module 114 of analysis system 112. Service 104C receives authentication request 132C from user device 110C, and outputs login data 122C to collector module 114 of analysis system 112. Analysis system 112 stores login data 122A, 122B, and 122C. In addition, one or more of nodes 106 may output network data 124 to analysis system 112. Collector module 114 of analysis system 112 receives instances of network data 124 and stores network data 124.

Analysis system 112 may determine a baseline of network activity (502). For example, analysis system 112 analyzes the collected information (e.g., login data 122A, 122B, 122C, and/or network data 124). Analysis system 112 determines normal network behavior associated with each of users 111 and/or user devices 110. Analysis system 112 may also determine normal network behavior for each type of user 111 (e.g., marketing personnel, sales personnel, etc.) or each type of user device 110 (e.g., devices associated with marketing operations, devices associated with sales operations). Analysis system 112 uses the information about normal network behavior to determine a baseline of network activity applicable in various contexts.

Analysis system 112 may collect a set of network activity data (503). For example, in FIG. 1B and after determining the baseline of network activity, user device 110A outputs authentication request 232A to network 102, representing a request based on input detected at user device 110A. Gateway 108 determines that authentication request 232A is intended for service 104A. Gateway 108 routes authentication request 232A to service 104A. Service 104 receives authentication request 232A and determines whether to authenticate user device 110A. In some examples, service 104 outputs information about authentication request 232A to analysis system 112. In other examples, analysis system 112 observes authentication request 232A on the network without receiving information about authentication request 232A from service 104A.

Analysis system 112 may identify the network activity data as anomalous (504). For example, analysis system 112 evaluates authentication request 232A and compares authentication request 232A and related network activity to the baseline of network activity for user device 110A and/or user 111A. In some examples, analysis system 112 may apply unsupervised model 116U to determine whether authentication request 232A and/or related network activity are anomalous relative to the baseline of network activity. If model 116U determines that the network activity is not anomalous, analysis system 112 might not take any remediation actions (NO path from 504). If model 116U determines that authentication request 232A and related network activity are anomalous (YES path from 504), model 116U outputs anomaly score 332A. Anomaly score 332A may include information about the extent to which authentication request 232A and related data are considered anomalous.

Analysis system 112 may classify the network data into a threat category (505). For example, analysis system 112 may apply tagging rules to authentication request 232A and related network activity that enable anomaly score 332A to be translated into a threat category, which may be an identifiable or known network activity pattern. In other examples, analysis system 112 may apply supervised model 116S to authentication request 232A and related network activity in order to classify authentication request 232A into a threat category.

Analysis system 112 may take action to mitigate a security threat posed by the network activity data (506). For example, analysis system 112 may take action to mitigate a security threat posed by the network activity data. In some examples, analysis system 112 may take action by outputting control signals 191 to remediation systems 190, which may cause remediation system 190 to output control signals 192 to controlled system 193. Accordingly, analysis system 112 controls remediation system 190 and/or controlled system 193 based on anomaly score 332 and/or the classified threat category.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are each hereby incorporated by reference in their entireties. To the extent that any such disclosure material that is incorporated by reference conflicts with the instant disclosure, the instant disclosure shall control.

For ease of illustration, only a limited number of devices (e.g., analysis computing system 112 as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
obtaining, by a computing system, historical network activity data that includes information about authentication traffic within a network;
determining, by the computing system and based on the historical network activity, a baseline of network activity;
collecting, by the computing system, a set of network activity data;
applying, by the computing system, an unsupervised algorithm to identify the set of network activity data as anomalous relative to the baseline of network activity;
classifying, by the computing system, the network activity data into an identified threat category from among a plurality of threat categories; and
taking action, by the computing system and based on the identified threat category, to mitigate a security threat posed by the network activity data.

2. The method of claim 1, wherein classifying the network activity data into the identified threat category includes:
enabling a subject matter expert to create rules for each of the plurality of threat categories; and
applying the rules to classify the network activity data into the identified threat category.

3. The method of claim 2, wherein the set of network activity data is a first set of network activity data, and wherein the method further comprises:
collecting, by the computing system, a second set of network activity data;
applying, by the computing system, the unsupervised algorithm to identify the second set of network activity data as anomalous relative to the baseline of network activity;
determining, by the computing system, that the second set of network activity data is not classifiable into any of the plurality of threat categories; and
taking action, by the computing system and based on identifying the second set of recent network activity data as anomalous, to mitigate a security threat posed by the second set of network activity data.

4. The method of claim 3, wherein determining that the second set of network activity data is not classifiable into any of the plurality of threat categories includes:
applying the rules to the second set of network activity data; and
determining that applying the rules does not classify the second set of network activity data into any of the plurality of threat categories.

5. The method of claim 2, wherein enabling the subject matter expert to create rules includes:
receiving an indication of input from a subject matter expert computing system operated by the subject matter expert; and
creating, based on the indication of input, tagging rules for each of the plurality of threat categories.

6. The method of claim 1, wherein the unsupervised algorithm is an unsupervised machine learning model, and wherein the method further comprises:
training, by the computing system, the unsupervised machine learning model using the historical network activity data.

7. The method of claim 1, wherein classifying the network activity data into the identified threat category includes:
labeling at least some of the historical network activity data with one or more of the plurality of threat categories;
training a supervised machine learning model to classify network activity data into at least one of the plurality of threat categories; and
applying the supervised machine learning model to the network activity data to classify the network activity data into the identified threat category.

8. The method of claim 1, wherein determining the baseline of network activity includes:
identifying normal logon behavior of each of a plurality of network users; and
identifying normal logon behavior of each of a plurality of types of network users.

9. The method of claim 8, wherein determining the baseline of network activity further includes:
identifying attributes of login behavior of each of the plurality of network users relative to other users.

10. The method of claim 9, wherein at least some aspects of the network are controlled by an organization, and wherein determining the baseline of network activity further includes:
identifying contextual information associated with the organization;
determining the baseline of network activity by taking into account the contextual information associated with the organization.

11. The method of claim 1, wherein taking action includes:
sending control signals to a controlled system instructing the controlled system to modify configurations of the network to mitigate the security threat.

12. A computing system comprising processing circuitry and a storage device, wherein the processing circuitry has access to the storage device and is configured to:
obtain historical network activity data that includes information about authentication traffic within a network;
determine based on the historical network activity, a baseline of network activity;
collect a set of network activity data;
apply an unsupervised algorithm to identify the set of network activity data as anomalous relative to the baseline of network activity;
classify the network activity data into an identified threat category from among a plurality of threat categories; and
take action, based on the identified threat category, to mitigate a security threat posed by the network activity data.

13. The computing system of claim 12, wherein to classify the network activity data into the identified threat category includes:
enable a subject matter expert to create rules for each of the plurality of threat categories; and
apply the rules to classify the network activity data into the identified threat category.

14. The computing system of claim 13, wherein the set of network activity data is a first set of network activity data, and wherein the processing circuitry is further configured to:
collect a second set of network activity data;
apply the unsupervised algorithm to identify the second set of network activity data as anomalous relative to the baseline of network activity;
determine that the second set of network activity data is not classifiable into any of the plurality of threat categories; and
take action, based on identifying the second set of recent network activity data as anomalous, to mitigate a security threat posed by the second set of network activity data.

15. The computing system of claim 14, wherein to determine that the second set of network activity data is not classifiable into any of the plurality of threat categories includes:
apply the rules to the second set of network activity data; and
determine that applying the rules does not classify the second set of network activity data into any of the plurality of threat categories.

16. The computing system of claim 13, wherein to enable the subject matter expert to create rules includes:
receive an indication of input from a subject matter expert computing system operated by the subject matter expert; and
create, based on the indication of input, tagging rules for each of the plurality of threat categories.

17. The computing system of claim 12, wherein the unsupervised algorithm is an unsupervised machine learning model, and wherein the processing circuitry is further configured to:
train the unsupervised machine learning model using the historical network activity data.

18. The computing system of claim 12, wherein to classify the network activity data into the identified threat category includes:
label at least some of the historical network activity data with one or more of the plurality of threat categories;
train a supervised machine learning model to classify network activity data into at least one of the plurality of threat categories; and
apply the supervised machine learning model to the network activity data to classify the network activity data into the identified threat category.

19. The computing system of claim 12, wherein to determine the baseline of network activity includes:
identify normal logon behavior of each of a plurality of network users; and
identify normal logon behavior of each of a plurality of types of network users.

20. Non-transitory computer-readable media configured with instructions that, when executed, cause one or more processors to:
obtain historical network activity data that includes information about authentication traffic within a network;
determine, based on the historical network activity, a baseline of network activity;
collect a set of network activity data;
apply an unsupervised algorithm to identify the set of network activity data as anomalous relative to the baseline of network activity;
classify the network activity data into an identified threat category from among a plurality of threat categories; and
take action, based on the identified threat category, to mitigate a security threat posed by the network activity data.
